(19) United States
(12) Patent Application Publication
(10) Pub. No.: US 2024/0333166 A1
(43) Pub. Date: Oct. 3, 2024

(54) Soft Switching, Flyback Derived, Single Ended Asymmetrical Half Bridge, Using Voltage And Current Injection

(71) Applicant: Rompower Technology Holdings, LLC, Milford, DE (US)

(72) Inventor: Ionel Jitaru, Tucson, AZ (US)

(73) Assignee: Rompower Technology Holdings, LLC, Milford, DE (US)

(21) Appl. No.: 18/743,055

(22) Filed: Jun. 13, 2024

Related U.S. Application Data
(63) Continuation-in-part of application No. 18/199,959, filed on May 21, 2023.
Application No. 18/199,959 is a continuation of application No. 17/495,170, filed on Oct. 6, 2021, now Pat. No. 11,671,027.
Application No. 17/495,170 is a continuation of application No. 16/751,747, filed on Jan. 24, 2020, now Pat. No. 11,165,360.
Application No. 16/751,747 is a continuation of application No. 16/503,432, filed on Jul. 3, 2019, now Pat. No. 10,574,148.
(63) Continuation-in-part of application No. 18/233,315, filed on Aug. 12, 2023.
Application No. 18/233,315 is a continuation of application No. 17/495,245, filed on Oct. 6, 2021, now Pat. No. 11,728,723.
Application No. 17/495,245 is a division of application No. 15/825,647, filed on Nov. 29, 2017, now Pat. No. 11,152,847.
(60) Provisional application No. 63/508,252, filed on Jun. 14, 2023.
(60) Provisional application No. 63/508,254, filed on Jun. 14, 2023.
(60) Provisional application No. 62/429,373, filed on Dec. 2, 2016.

(51) Int. Cl. H02M 3/335; H02M 1/00; H02M 7/217

(52) U.S. Cl. CPC H02M 3/33592; H02M 1/0061; H02M 7/217; H02M 1/0003; H02M 1/0058; H02M 3/33576

(57) ABSTRACT

Electronic circuitry and a method of operating the same to obtain zero voltage switching on both primary switches in a flyback derived single ended asymmetrical half bridge topology, in all the operating conditions, both in continuous and discontinuous mode operation. Zero voltage switching is accomplished through voltage injection and through a combination of the voltage injection and current injection.

### CROSS-REFERENCE TO RELATED APPLICATIONS

This application is a continuation-in-part of and claims the benefit of prior U.S. patent application Ser. No. 18/233,315, filed Aug. 12, 2023, is a continuation-in-part of and claims the benefit of prior U.S. patent application Ser. No. 18/199,959, filed May 21, 2023, claims the benefit of prior U.S. Provisional Application No. 63/508,254, filed Jun. 14, 2023, and claims the benefit of prior U.S. Provisional Application No. 63/508,252, filed Jun. 14, 2023, all of which are hereby incorporated by reference in their entireties.

### FIELD

The present specification relates generally to power conversion, and more particularly to power converters configured around a flyback-derived, single-ended asymmetrical half bridge.

### BACKGROUND

The flyback topology is one of the most used circuit topologies in the field of power conversion, especially in lower power levels to 70 W. The flyback topology can provide very good performances also for higher power levels from 100 W to 150 W and even higher power; the flyback topology works together with a Power Factor Correction circuit and as a result the input power voltage range is reduced from 90Vac to 264Vac to 300Vdc to 400Vdc. However, the flyback topology contains only one power switch and performances may decay at power levels from 150 W to 300 W.

In the middle range of powers, 100 W to 300 W, the half bridge derived topologies can provide higher efficiency especially if the new standards for power delivery require that the adapters provide a voltage output ranging from 5V to 48V. Most of the traditional forward-derived topologies (such as, for example, half-bridge topology, two-transistor forward topology, full bridge topology, to name just a few) are not able to operate efficiently over such large input and output voltage ranges.

In conventional half bridge and full bridge topologies, where the output power is controlled through pulse width modulation, the dead time in between the control of the upper and lower switch is varying in a significant range and during the dead time there is a ringing in between the leakage inductance and the parasitic capacitance reflected across the primary switching elements. In addition to that, the switching elements turn on in a hard switching mode. For that reason, in U.S. Pat. No. 5,231,563, Jitaru introduced the concept of asymmetrical half bridge wherein the dead time in between the switching elements is constant and it does allow in some applications to obtain zero voltage switching on the switching elements. The flyback derived, single ended asymmetrical half bridge topology, known in the industry as hybrid flyback, is a public-domain topology.

### SUMMARY

Embodiments disclosed herein improve the performance of the flyback derived, single ended asymmetrical half bridge and simplify the control algorithm wherein zero voltage switching is accomplished in any operating condition.

In an embodiment, a method of operating a DC-DC converter includes providing a DC-DC converter having a primary side and a secondary side, an input voltage source, a transformer having at least one primary winding at the primary side and at least one secondary windings at the secondary side, wherein a leakage inductance is formed between the at least one primary winding and the secondary winding, wherein there is a magnetizing current flowing through the primary and secondary winding. The converter further includes two switching elements in a totem pole, including a lower switching element connected to a first termination of the input voltage source and an upper switching element connected to a second termination of the input voltage source, a switching node which is a common connection between the lower switching element and the upper switching element, a resonant capacitor connected to one end of the primary winding, and the resonant capacitor in series with the primary winding connected across the lower switching element. The converter further includes an output capacitor, a rectifier means having two power terminations connected with the first power termination to one end of the secondary winding and the end of the secondary winding not connected to the rectifier means, connected to the first termination of the output capacitor, wherein the second termination of the output capacitor is connected to the second power termination of the rectifier means, and an output load connected across the output capacitor. The method includes: (a) switching on the upper switching element for a time interval referred to as the upper switch on time during which the magnetizing current is building up through the transformer; (b) the upper switching element is turned off for a time interval referred to as a first dead time period; (c) the lower switching element is switched on for a for a time interval referred to as the lower switch on time during which the magnetizing current is decaying in amplitude and when the resonant capacitor form a resonant circuit with the leakage inductance of the transformer and a sinusoidal shaped current will flow into secondary winding and rectifier means charging the output capacitor and the sinusoidal shaped current flowing in the secondary reaching zero amplitude at a time named trez; (d) the lower switch on time is longer than the trez; (e) the magnetizing current becomes negative reaching a negative amplitude IM-neg; (f) the lower switching element is turn off for a time interval referred as the second dead time period; (g) after the second dead time period, the upper switch turns on, initiating another cycle; and (h) cyclically repeating at least steps (a) through (f).

In embodiments, the magnetizing current at the end of the second dead time period has an amplitude sufficient to charge a parasitic capacitance reflected in the switching node to create zero voltage switching conditions for the upper switch at turn on.

In an embodiment, a method of operating a DC-DC converter includes providing a DC-DC converter having a primary side and a secondary side, an input voltage source, a transformer having at least one primary winding at the primary side and at least one secondary windings at the secondary side, wherein a leakage inductance is formed between the at least one primary winding and the secondary winding, wherein there is a magnetizing current flowing through the primary and secondary winding, two switching elements in a totem pole, having a lower switching element connected to a first termination of the input voltage source and an upper switching element connected to a second termination of the input voltage source, a switching node which is a common connection between the lower switching element and the upper switching element, and a resonant capacitor connected to one end of the primary winding, and the resonant capacitor in series with the primary winding connected across the lower switching element. The converter includes an output capacitor, a rectifier means having two power terminations connected with the first power termination to one end of the secondary winding and the end of the secondary winding not connected to the rectifier means, connected to the first termination of the output capacitor, wherein the second termination of the output capacitor is connected to the second power termination of the rectifier means, an output load connected across the output capacitor, and an auxiliary circuit formed by a third switching element in series with a diode and further in series with a floating voltage source Vinj, with its positive polarity connected to an anode of the diode wherein the auxiliary circuit is connected across the primary of the transformer.

The method includes: (a) switching on the upper switching element for a time interval referred as the upper switch on time; the upper switch on time wherein the magnetizing current is building up through the transformer; (b) the upper switching element is turned off for a time interval referred as first dead time period; (c) the lower switching element is switched on for a for a time interval referred as the lower switch on time wherein the magnetizing current is decaying in amplitude and when the resonant capacitor form a resonant circuit with the leakage inductance of the transformer and a sinusoidal shaped current will flow into secondary winding and rectifier means charging the output capacitor and the sinusoidal shaped current flowing in the secondary reaching zero amplitude at a time named trez; (d) wherein the third switching element is turned on during the lower switch on time; (e) the lower switch on time is longer than the trez; (f) the magnetizing current becomes negative reaching a negative amplitude IM-neg; (g) the third switching element turns off prior the time the upper switching element turns on with a defined time period; (h) the lower switching element is turn off for a time interval referred as the second dead time period; (i) after the second dead time period, the upper switch turns on, initiating another cycle; and (j) cyclically repeating at least steps (a) through (h).

In embodiments, the magnetizing current at the end of the second dead time period has an amplitude sufficient to charge a parasitic capacitance reflected in the switching node to create zero voltage switching conditions for the upper switch at turn on.

In embodiments, Vinj has a value such that the negative magnetizing current IM-neg has an amplitude sufficient to charge a parasitic capacitance reflected in the switching node to create zero voltage switching conditions for the upper switch at turn on.

In embodiments, Vinj has a value such that increases to a given amplitude for a determined period of time prior to an end of the second dead time so as to charge a parasitic capacitance reflected in the switching node to create zero voltage switching conditions for the upper switch at turn on.

In an embodiment, A method of operating a DC-DC converter includes providing a DC-DC converter having a primary side and a secondary side, an input voltage source, and a transformer having at least one primary winding at the primary side and at least one secondary windings at the secondary side, wherein a leakage inductance is formed between the at least one primary winding and the secondary winding, wherein there is a magnetizing current flowing through the primary and secondary winding. The converter includes two switching elements in a totem pole, having a lower switching element connected to a first end of the input voltage source and an upper switching element connected to a second end of the input voltage source, a switching node which is a common connection between the lower switching element and the upper switching element, a resonant capacitor connected to one end of the primary winding, and the resonant capacitor in series with the primary winding both in series connected across the lower switching element, and an output capacitor. The converter further includes a rectifier means having two power terminations connected with the first power termination to one end of the secondary winding and the end of the secondary winding not connected to the rectifier means, connected to the first termination of the output capacitor, wherein the second termination of the output capacitor is connected to the second power termination of the rectifier means, an output load connected across the output capacitor, a current injection winding in the transformer connected to a circuit formed by two legs; wherein the first leg is formed by a p channel mosfet in series with a diode and wherein the second leg is formed by a n channel mosfet in series with a diode, the current injection winding not connected to the circuit formed by two legs is connected to a current injection capacitor, wherein the termination of the capacitor not connected to the current injection winding is connected to the sources of p channel mosfet and n channel mosfet, and an auxiliary circuit formed by a third switching element in series with a diode and further in series with a floating voltage source Vinj, with positive polarity, connected to an anode of the diode wherein the auxiliary circuit is connected across the primary of the transformer.

In embodiments, the method includes: (a) switching on the upper switching element for a time interval labeled the upper switch on time; the upper switch on time wherein the magnetizing current is building up through the transformer; (b) the upper switching element is turned off for a time interval labeled first dead time period; (c) the lower switching element is switched on for a for a time interval labeled the lower switch on time wherein the magnetizing current is decaying in amplitude and when the resonant capacitor form a resonant circuit with the leakage inductance of the transformer and a sinusoidal shaped current will flow into secondary winding and rectifier means charging the output capacitor and the sinusoidal shaped current flowing in the secondary reaching zero amplitude at a time named trez; (d) wherein the third switching element is turned on during the lower switch on time; (e) the lower switch on time is longer than the trez; (f) wherein the magnetizing current becomes negative reaching a negative amplitude IM-neg; (g) the lower switching element is turn off for a time interval labeled the second dead time period; (h) the third switching element turns off prior the time the upper switching element turns on with a defined time period; (i) switching on the n channel mosfet for a given time interval at the end of second dead time, wherein a quasi resonant current pulse is flowing from the current injection capacitor and the current injection winding, further induced in the primary winding and to charge a parasitic capacitance reflected in the switching node to create zero voltage switching conditions for the upper switch at turn on; (j) after a given time period, during a conduction of the upper switch the p channel mosfet is switched on and a quasi resonant current starts flowing through the primary winding and further induced in the current injection winding, charging the current injection capacitor with energy from the input voltage source; (k) after the second dead time period, the upper switch turns on, initiating another cycle; and (l) cyclically repeating at least steps (a) through (j).

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 illustrates a flyback derived, single ended asymmetrical half bridge topology using synchronous rectification;

FIG. 2 illustrates waveforms of operation of a flyback derived single ended asymmetrical half bridge topology operating in continuous mode;

FIG. 3 illustrates waveforms of a flyback derived, single ended asymmetrical half bridge operating in continuous mode, wherein the upper switch in the half bridge turns on in hard switching mode;

FIG. 4 illustrates waveforms of a flyback derived, single ended asymmetrical half bridge operating in discontinuous mode, wherein the upper switch in the half bridge turns on in hard switching mode;

FIG. 5 illustrates waveforms of a flyback derived, single ended asymmetrical half bridge operating in discontinuous mode to obtain zero voltage switching at turn on for the upper which of said half bridge;

FIG. 6 illustrates a flyback derived, single ended asymmetrical half bridge topology using synchronous rectification using energy injection, which is one of the embodiments described herein;

FIG. 7 illustrates waveforms of a flyback derived, single ended asymmetrical half bridge topology using synchronous rectification operating in continuous and discontinuous mode using voltage injection, which is one of the embodiments of described herein;

FIG. 8 illustrates a flyback derived, single ended asymmetrical half bridge topology using synchronous rectification using voltage injection together with current injection, which is one of the embodiments described herein;

FIG. 9 illustrates waveforms of a flyback derived, single ended asymmetrical half bridge topology using synchronous rectification operating in continuous and discontinuous mode using voltage injection and current injection, which is one of the embodiments described herein;

FIG. 10 illustrates a flyback derived, single ended asymmetrical half bridge topology using synchronous rectification using voltage injection together with Rompower current injection;

FIG. 11 illustrates a flyback derived, single ended asymmetrical half bridge topology using synchronous rectification using voltage injection together with current injection;

FIG. 12 illustrates a flyback derived, single ended asymmetrical half bridge topology using synchronous rectification together with current injection;

FIG. 13 illustrates waveforms of the flyback derived, single ended asymmetrical half bridge topology operating in continuous mode and using current injection;

FIG. 14 illustrates waveforms of the flyback derived, single ended asymmetrical half bridge topology operating in discontinuous mode and using current injection;

FIG. 15A illustrates a flyback derived, single ended asymmetrical half bridge topology using synchronous rectification together with the first embodiment for current injection;

FIG. 15B illustrates waveforms of the flyback derived, single ended asymmetrical half bridge topology operating in continuous mode and using the first embodiment for current injection;

FIG. 16A illustrates a flyback derived, single ended asymmetrical half bridge topology using synchronous rectification together with the second embodiment for current injection;

FIG. 16B illustrates waveforms of the flyback derived, single ended asymmetrical half bridge topology operating in continuous mode and using the second embodiment for current injection;

FIG. 17A illustrates a flyback derived, single ended asymmetrical half bridge topology using synchronous rectification together with the third embodiment for current injection;

FIG. 17B illustrates waveforms of the flyback derived, single ended asymmetrical half bridge topology operating in continuous mode and using the third embodiment for current injection; and

FIG. 18 illustrates a flyback derived, single ended asymmetrical half bridge topology using synchronous rectification together with floating voltage injection.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

Embodiments disclosed herein improve the performance of the flyback derived, single ended asymmetrical half bridge and simplify the control algorithm wherein zero voltage switching is accomplished in any operating condition.

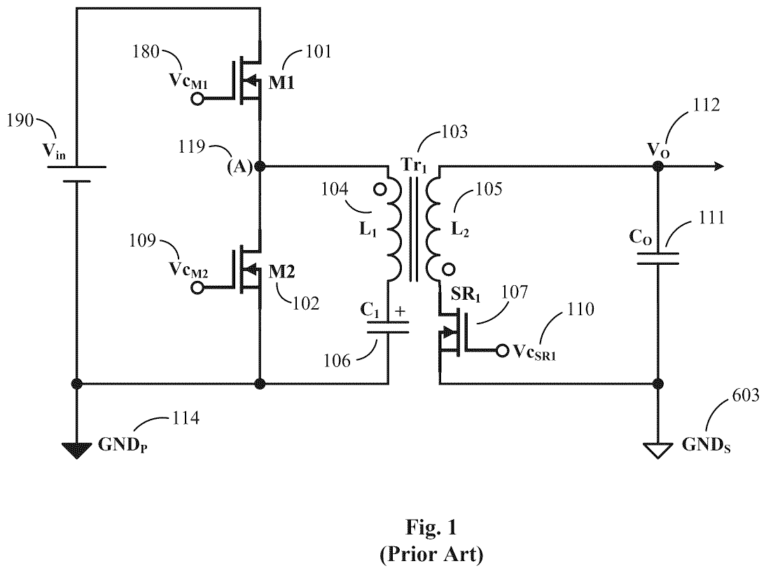

FIG. 1 illustrates a simplified schematic of electronic circuitry of a power converter utilizing the flyback derived, single ended asymmetrical half bridge topology. It includes two totem pole switchers, M1, 101, and M2, 102, and a transformer Tr1, 103, which includes a primary winding L1, 104 and a secondary winding, L2 105 wherein the primary winding is connected to the connecting between M1 and M2, referred to herein as a switching node A, 119 and the second termination of the primary winding is connected to the resonant capacitor C1, 106. The drain of M1, 101 is connected to the input voltage source, Vin, 190 and the source of M2, 102 and the termination of C1, 106 not connected to the primary winding are connected to the negative polarity of the input voltage source Vin, 190, and to the input ground, GNDp, 114.

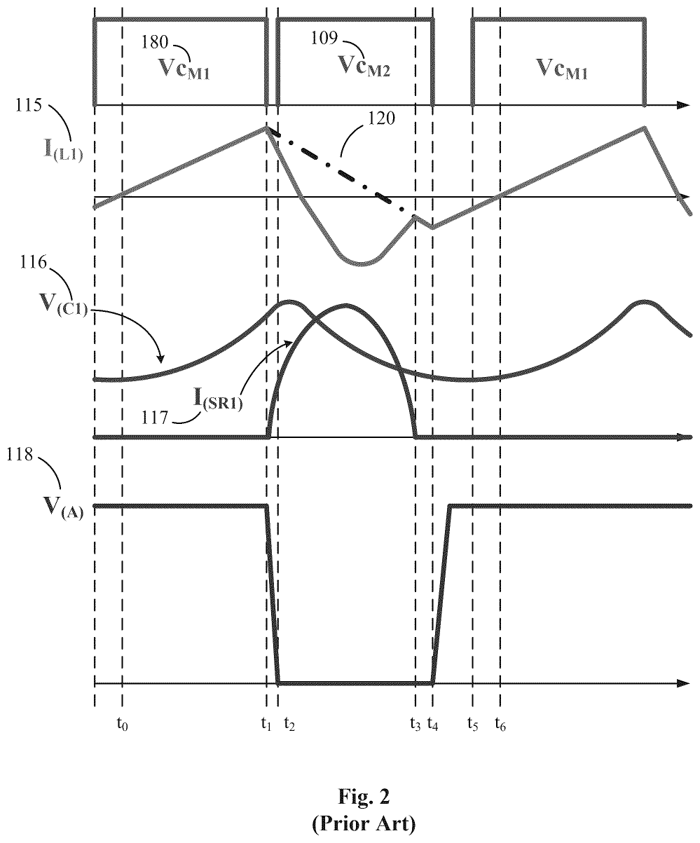

The mode of operation of the single ended asymmetrical half bridge is depicted in FIG. 2. In FIG. 2 are depicted waveforms such as VcM1, (180) and VcM2, (109) which represent the control signal for M1, 101, and M2, 102. FIG. 2 further presents the current through L1, 115 and the magnetizing current, 120. Further in FIG. 2 is presented also the voltage across the resonant capacitor C1, V(C1), 116 and the current through the secondary synchronous rectifier SR1, I(SR1), 117. Further in FIG. 2 is depicted also the voltage in the switching node, A, V(A), 118.

The waveforms depicted in FIG. 2 apply for the operation in continuous mode. As defined herein, the continuous mode operation is the operation wherein the Vc1M1 and Vc2M2 are successive to each other with a given dead time in between and without blanking phases. In discontinuous mode of operation there is an extended dead time following the on time of M2, 102, when no energy is processed, said extended dead time which is several times larger than the said dead time between VcM1, 180, and VcM2, 109 in continuous mode of operation.

At very low output power there are two modes of operation. In one mode, the on time for M1 switch is on followed by an on time of M2 switch and followed by an extended dead time. In addition to the modulation of on time of the M1 switch, the extended dead time can be also modulated to decrease the power taken form the input.

A second mode of operation at light load uses a train of pulses, which are a succession of on time for M1 switch followed by on time for M2 switch, operation as described in continuous mode, followed by a control period of the extended dead time.

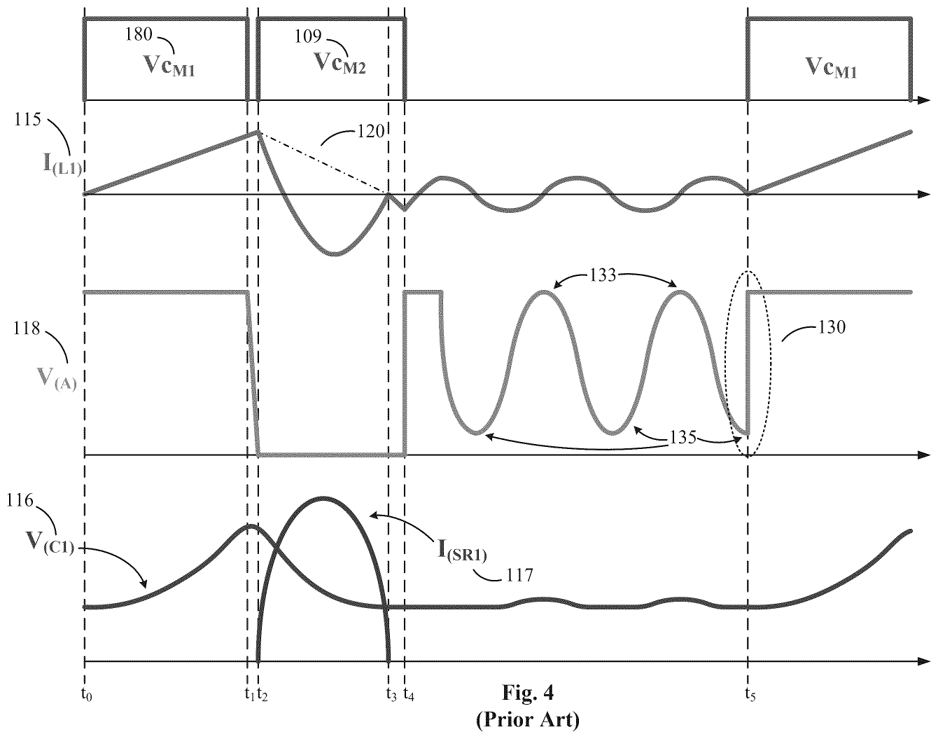

Like the flyback topology operating in discontinuous mode during the extended dead time, there is an oscillation caused by the resonance in between the primary inductance L1, 104, and the parasitic capacitance reflected in the switching node A. 119 as depicted in FIG. 4.

Between t0 to t1 the upper switch M1, 101 is turned on and the current through the transformer primary winding, L1, 104 is building up until it reaches a determined peak level.

At t1, the upper switch M1, 101, turns off and the magnetizing current in the transformer Tr1, 103 forces the conduction further through the body diode of M2, 102. The interval t1 to t2 by design is made to be relatively short to minimize the dissipation through the body diode.

At t2, the lower switch M2, 102 is turned on and the magnetizing current continues to flow through M2, L1 and resonant capacitor C1, 106. The magnetizing current is depicted in a dotted line, 120. In addition to the flow of the magnetizing current there is another quasi-resonant current which is the result of the resonance in between the resonant capacitor C1, 106 and the leakage inductance between L1, 104 and L2, 105, of the transformer Tr1, 103. The current reflected in the secondary has a half sinusoidal shape. The half sinusoidal shape of the secondary current, reflected in the primary via L1, 104 is added to the magnetizing current flowing in the primary winding as depicted by I(L1), 115 from FIG. 2.

At t3, the current in the secondary through SR1, reaches zero and turns off the SR1. The SR1 can be replaced by a diode function of the application. In this specification, SR1 is referred to as a “rectification means” which includes any rectification device which conducts in one direction, and it is an open circuit when the current reverses.

Between t3 to t4, the current in the primary winding L1, 104, is reduced to the magnetizing current. The voltage across the C1 continues to increase the magnetizing current into the negative polarity. The longer the time interval between t3 to t4 the larger the decay of the magnetizing current into a negative polarity.

The negative magnetizing current charges the parasitic capacitance reflected in the switching node A, 119 and flows further through the body diode of M1, 101 creating zero voltage switching condition somewhere in between t4 to t5. The time interval t3 to t4 is thus has a consequence.

At t5, the upper switch M1, 101, is turned on at zero voltage switching conditions.

At t6, the magnetizing current, 120, crosses zero and the cycle repeats again.

During the time interval t0-t1, energy is extracted from the input voltage source and is injected in the magnetizing current of Tr1, 103 and in the same time energy is injected into the resonant capacitor C1, 106. During the time interval between t2 to t3 the energy extracted from Vin, 190, in between t0 to t1, is delivered to the output via the rectifier means, SR1. A significant portion of the energy transferred to the secondary is done in a resonant way, wherein the current in the secondary is shaped in half sinusoidal shape. In between t2 to t3 a quantum of energy is transferred to the secondary.

### Example 1: Hard Switching in Continuous and Discontinuous Mode Operation

To improve performance in respect of efficiency for the flyback derived single ended asymmetrical half bridge both switchers, M1, 101, and M2, 102, turn on at zero voltage switching conditions.

Zero voltage switching not only minimizes switching losses but also eliminates spikes and glitches across the secondary rectifier means, SR1, 107. When the switching elements M1, 101 and M2, 102, turn on in hard switching mode, spikes and glitches occur across SR1, 107. To reduce the amplitude of the spikes and glitches, snubbers are placed across SR1 which will lead to additional power dissipation losses in addition to the switching losses. The bottom switch, M2, 102, turns on at zero voltage switching conditions because it turns on after the body diode of M2, which occurs after M1 turns off at t1 as depicted in FIG. 2, forced by the magnetizing current in the transformer Tr1, 103.

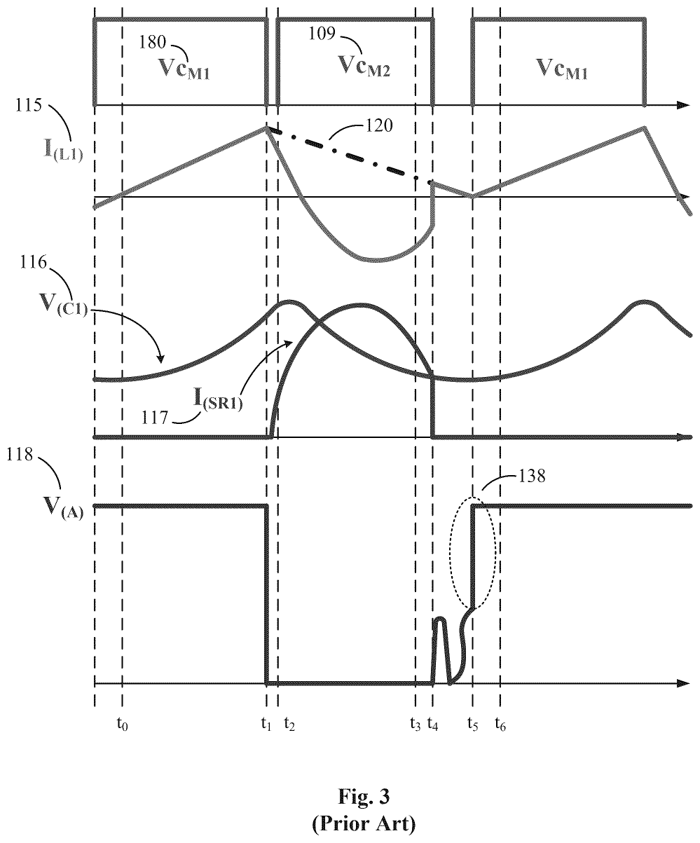

For switch M1, 101, there are conditions wherein zero voltage switching does not occur. FIG. 3 presents such a condition. The conduction time of M2. 102, is not adjusted for the operating conditions and M2, 102, turns off prior the resonant cycle end, which means before the resonant current in the secondary did not reach zero, and in addition to that the magnetizing current did not have sufficient negative amplitude in order to flow through the upper switch M1, 101, and force the body diode of M1 into conduction to create zero voltage switching conditions for M1, 101. Such a condition is depicted in FIG. 3, wherein the current in the secondary, I(SR1) did not finish its resonant cycle wherein its amplitude should reach zero. The resonant current through SR1, 107 is truncated and the same effect occurs in the primary winding for I(L1). In FIG. 3 the magnetizing current 120 did not become negative as depicted in FIG. 2 and the switch M1 turns on in hard switching mode at t5, visualized in area 138.

This problem can be avoided by using an intelligent controller which predicts the magnetizing current and by measuring the peak input current predicts how long to delay the turn off M2, 102, in such way that the magnetizing current to have the proper negative amplitude to ensure zero voltage switching for M1, 101.

The operation in discontinuous mode, hard switching for M1, 101, may occur as well as depicted in FIG. 4. In FIG. 4, the M1, 101, switch is on in between t0 to t1, followed by the dead time from t1 to t2 further followed by the turning on of M2 switch, between t2 to t4. During the “extended dead time”, which occurs after t4 there is an oscillation between the primary inductance L1, 104 of the transformer Tr1, 103 and the parasitic capacitance reflected in the switching node A, 119. The parasitic capacitance reflected in the switching node incorporates the parasitic capacitances of M1, 101, and M2, 102, and additional parasitic capacitance reflected across the primary winding of the transformer Tr1.

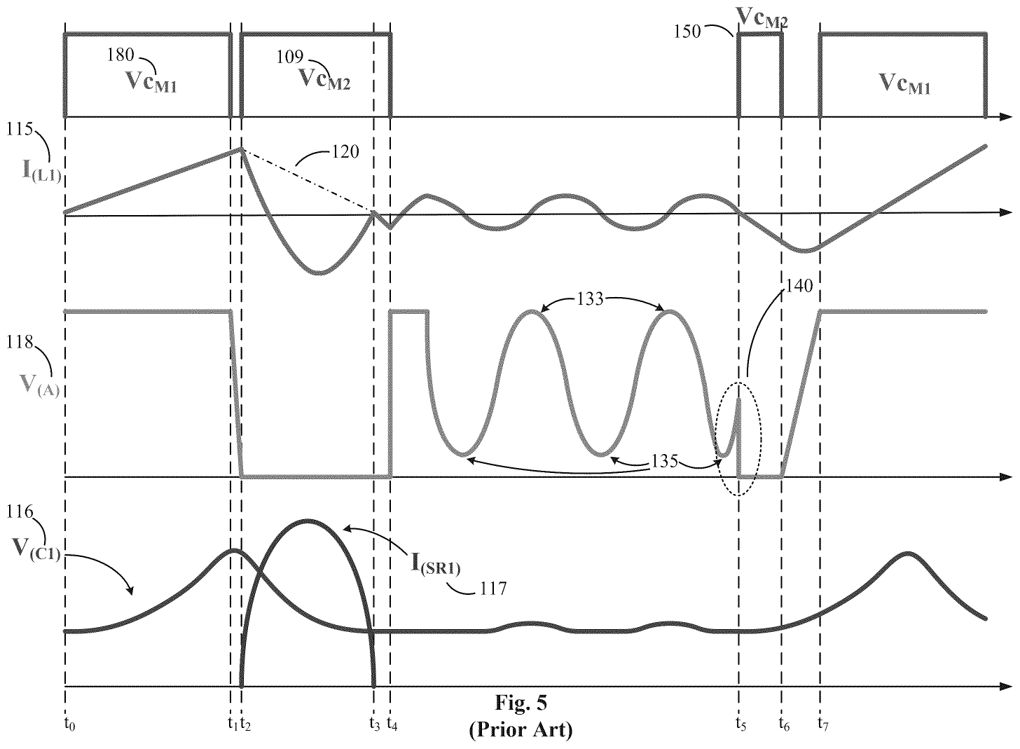

The said oscillations are depicted in V(A), 118 and I(L1), 115 in between t4 to t5 in FIG. 5. These oscillations have peaks (hills), 133, and valleys, 135. At t5 when the upper switch M1, 101, turns on in hard switching mode, area depicted by 130, the voltage in A, 119 is at the valley and the parasitic capacitances reflected in A, 119, has to be charged from the valley level to the Vin level in hard switching mode. This leads to switching losses and in addition to voltage spikes and glitches across SR1, 107.

As depicted in FIG. 5 after the typical cycle of turning on the upper switch M1 followed by the lower switch M2. After that from t4 to t5 we have the extended dead time with the oscillation caused by the resonant circuit formed by the parasitic capacitance reflected in switching node A, 119, and the primary inductance, L1, 104. In the waveforms depicted in FIG. 5, the bottom switch M2, 102 is turned on ahead of upper switch M1 for a determined time period, t5 to t6. During this time, the magnetizing current will build up increasing the negative amplitude of the magnetizing current in such a way that after t6 the negative magnetizing current will ensure the discharge of the parasitic capacitance reflected across M1, 101, and create zero voltage switching conditions for M1, 101. The brief turn on of M2, 102, shall be activated on the valley (135) of the voltage in the switching node A, 119, in order to minimize the turn on losses on M2 at turn on. The turn on of the M2, 102, will not be at zero voltage switching, the best case is to turn on, on the valley, 135. This is one of the drawbacks of this prior art solution.

In a power converter which has one or more primary switchers connected to the primary winding, wherein hard switching is intended to be replaced by a soft switching for a given primary switch, labeled M_Switch. “Hard switching” is defined herein as the turn on of a switching element wherein there is a voltage present across it, said voltage stored in the parasitic capacitance reflected across the M_Switch. “Soft switching” is the turn on of a switching element wherein the voltage across M_Switch is zero, wherein the parasitic capacitance reflected across M_Switch was already discharged to zero when M_Switch is turned on.

### Embodiment 1

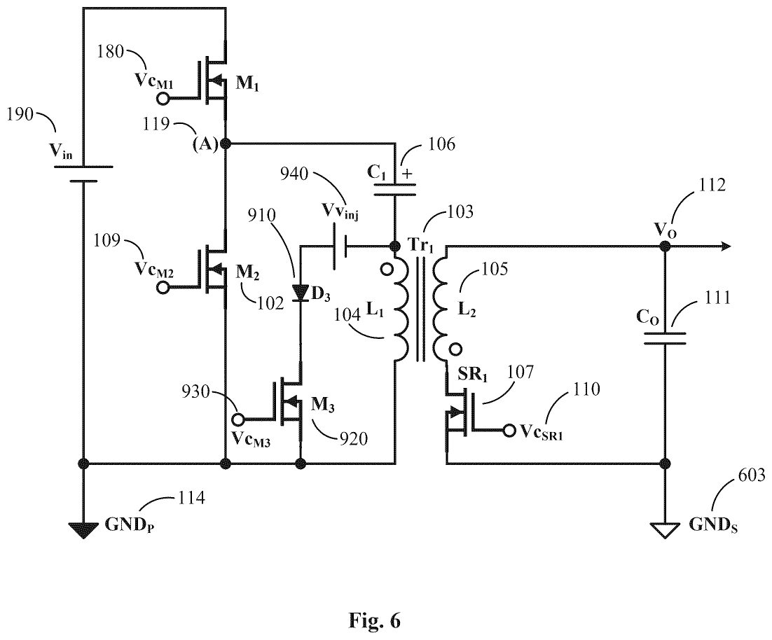

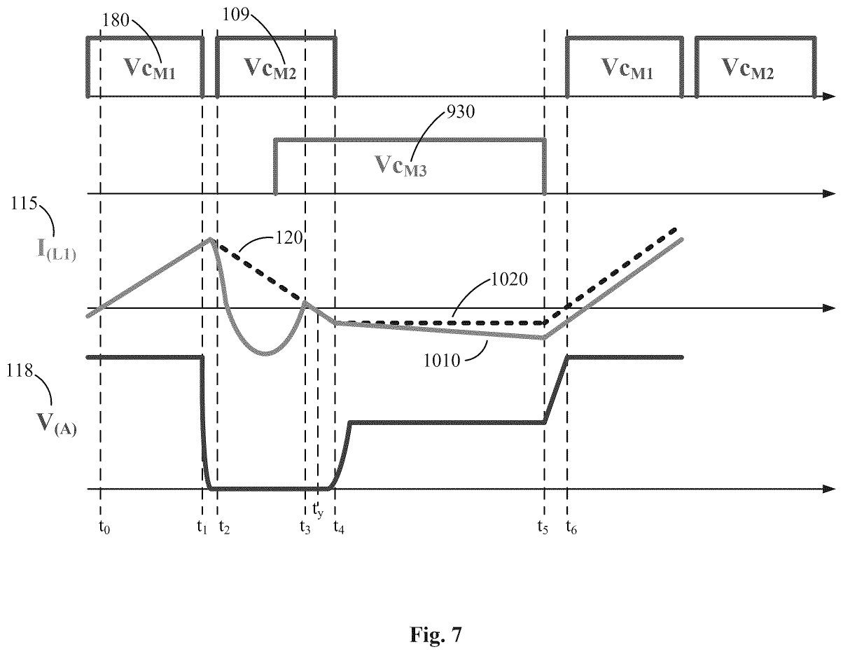

FIG. 6 depicts a flyback derived, single ended asymmetrical half bridge with an additional circuit formed by a voltage injection source Vvinj, 940, a diode D3, 910, and a controlled switch, 920, said switch being controlled by a control signal VcM3, 930. In FIG. 7 are depicted waveforms of the circuit presented in FIG. 6.

The waveforms depicted in FIG. 7 are: VcM1, 180, VcM2, 109, VcM3, 930, I(L1), 115, V(A), 118.

At the time M2, 102, turn off in the prior art in the switching node A, 119, there are oscillations as depicted in FIG. 4. Once the M3, 920, is turned on, the negative magnetizing current is “trapped” in the short on the loop created by Vvinj, 940, D3, 910, and M3, 920. For Vvinj of zero volt the magnetizing current will maintain the lower amplitude at t4, when M2, 102, is turned off. Its amplitude will maintain partially, until t5, with decay caused by the voltage across the diode D3 and due to the conduction losses. And after t5 the magnetizing current will charge the parasitic capacitance reflected in A, 119, until reaches Vin level as depicted by V(A).

At ty′, the magnetizing current reaches zero level and further the magnetizing current becomes negative when charged by the voltage on C1. At t4, the negative magnetizing current is charging the parasitic capacitance reflected in A, 119, and the voltage in A, will be Vin-V(C1). There will be no ringing in A as in prior art and the ringing energy will be preserved. The Vvinj will increase the negative amplitude of magnetizing current as depicted by 980, following principles described in U.S. Pat. No. 11,152,847. The Vvinj, 940, controls the negative amplitude of magnetizing current. A larger Vvinj, value the larger the negative amplitude of magnetizing current. By design this is tailored that the magnetizing current to have the proper amplitude in such way that at t5, when M3, 920 turns off, the magnetizing current should be able to charge the parasitic capacitance reflected in A, 119, to Vin level and in this way to create zero voltage switching conditions for M1, 101.

In this embodiment, the magnetizing current in the transformer Tr1, 103, can be controlled in two ways. The first method is extending the conduction time of M2, 102, which is visible in between ty′ to t4, wherein the negative magnetizing current amplitude increases from zero to the level of magnetizing current at t4. Further the magnetizing current can be increased by the value of Vvinj, 940. At lighter loads or higher input voltage conditions the extended dead time, between t4, and t6, and without Vvinj, 940, the amplitude of negative magnetizing current will decrease due to the power dissipation via, D3, 910, and M3, 920. The role of Vvinj is to maintain the amplitude of the negative magnetizing current and function of the application to increase it prior the next cycle when M1 will turn on to obtain zero voltage switching for M1, 101.

In conclusion in the embodiment 1, the amplitude of the negative magnetizing current, to obtain zero voltage switching on M1, 101, after M3, 920, turns off, can be controlled by the on time of M2, 109, as by the amplitude of Vvinj, 940. This embodiment also replaces the oscillating magnetizing current as in prior art depicted in FIGS. 4 and 5, by a DC magnetizing current. This eliminates the additional core loss caused by the ac component of the magnetizing current and additional losses in the primary winding due to AC losses in the winding and also eliminated the injection of AC signal in the circuits placed in the proximity of the transformer, leading to increase level of EMI. In many applications, the frequency of the oscillating depicted in FIGS. 4 and 5 between t4 to t5 has a frequency of several Mhz. To prevent the noise contamination some shielding may be needed around transformer Tr1, 103. The presence of M3, 920, eliminated the noise contamination, and reduces the losses in the transformer Tr1. In addition, Embodiment 1 allows the full control of the negative magnetizing current in such way that at the time M3, 920 turns off said magnetizing current will discharge the parasitic capacitance reflected across M1, 101, to create zero voltage switching conditions.

### Embodiment 2

In an application wherein extended dead time is very long Vvinj can be activated after a time interval after M2, 102, turns off. In this way the magnetizing current does not increase too much leading to an increased conduction loss. The Vvinj can be applied in advance to the turn on of M1, 101, for a given time period in such way that the amplitude of the negative magnetizing current is adequate to discharge the parasitic capacitance reflected across M1, 101, to zero and create zero voltage switching conditions for M1, 101. This embodiment is suitable for a light mode of operation wherein the extended dead time is very large and by using this embodiment, the efficiency can be maximized. Another method which is part of Embodiment 2 is when M3 is turned on to have a Vvinj at a low level just enough to maintain a constant level of negative magnetizing current. Prior to when M3 turns off, with a given time interval, the value of Vvinj increases and as result the value of the magnetizing current will increase reaching the proper level at t5, to discharge the parasitic capacitance reflected across M1, 101, to create zero voltage switching conditions for M1, 101.

### Embodiment 3

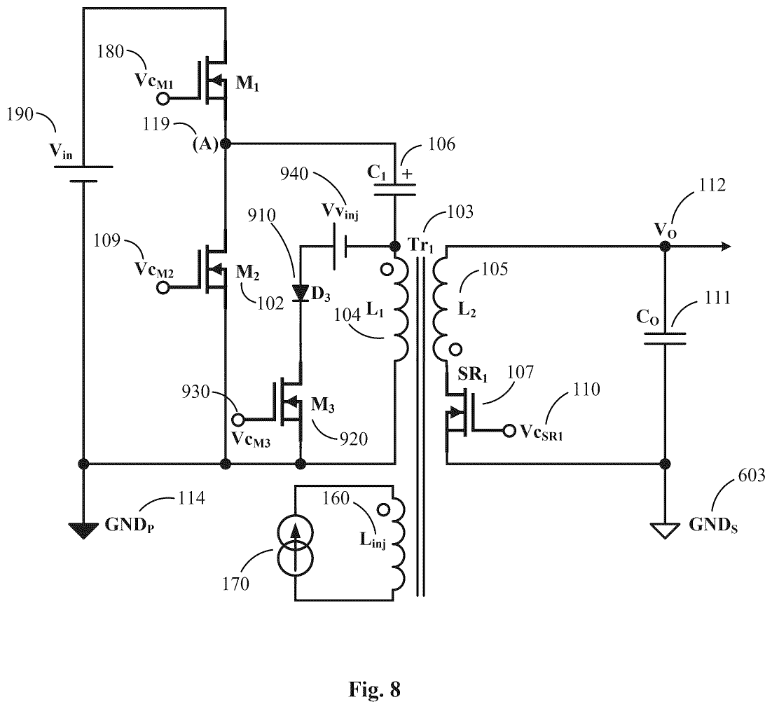

FIG. 8 presents another embodiment in which we combine the energy injection in the magnetizing current, described in Embodiment 1 and Embodiment 2 together with current injection. As is depicted in FIG. 8, the circuit presented is the same circuit as in FIG. 6 plus a current injection placed into an auxiliary winding Linj, 160.

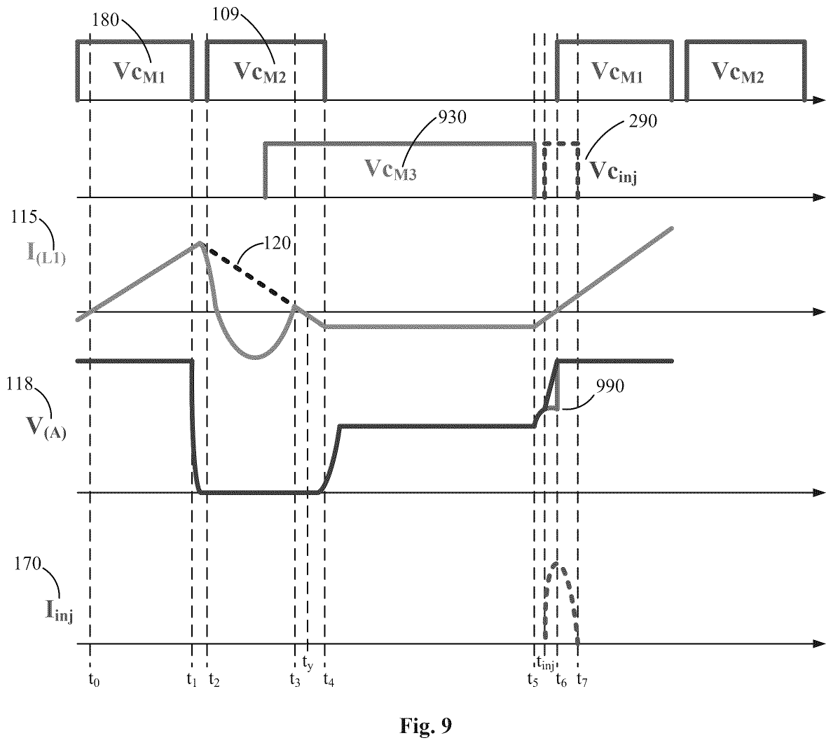

Waveforms of Embodiment 3 are presented in FIG. 9. FIG. 9 depicts the following waveforms: VcM1, 180, VcM2, 109, VcM3, 930, VcInj, 290, V(A), 118, and Iinj, 170.

Between t0 to t1, M1, 101 is on and the current builds up through L1, Energy is stored in magnetizing inductance and also in the capacitor C1.

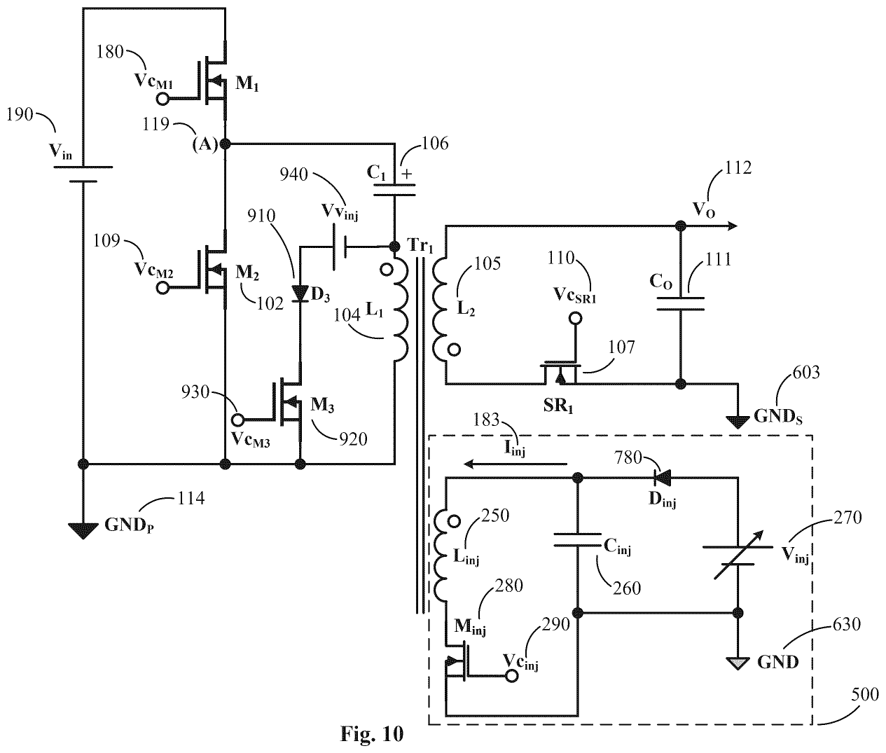

At t1 M1, 101, turns off and the magnetizing current discharges the parasitic capacitance reflected in A, 119, from Vin to zero in between t1 to t2. M2, 102 is on between t2 to t4. During this time period the magnetizing current decays from a peak level towards zero at ty and further to a negative value at t4. The negative magnetizing current is controlled by the time interval wherein M2 is on, between ty′ to t4. M3, 920, is turned on sometime between t2 and t4 when M2, 102 is conducting. The amplitude of the magnetizing current is preserved to the same amplitude during the conduction of M3, 920, in the event Vvinj has a voltage similar to the voltage across D3. In the event wherein Vvinj has a voltage higher than the voltage across D3, the magnetizing current builds up its negative amplitude, 1010, as depicted in FIG. 7. In some applications in which the amplitude of magnetizing current is not enough to create zero voltage switching condition for M1, when M1, 102, turns on a current injection is injected in the auxiliary winding Linj as depicted in FIG. 8. The current injection is controlled by Vcinj as presented in FIG. 9. The Vcinj is activated at tinj until t7, as depicted in FIG. 9, without current injection the voltage in A, 119, will start increasing from the level Vin-V(C1), 116, towards Vin. In FIG. 9 is depicted the case wherein the magnetizing current does not have sufficient amplitude to charge the parasitic capacitance reflected across A, 119, case depicted by 990. At t6 when M1, 102, is turned on in the case, 990, there will be a hard switching once M1, 102, will turn on. By activating the current injection at tinj, the current injection reflected into the primary winding L1, which will charge the parasitic capacitance reflected in the switching node, 119, to the Vin level, in such way that when M1, 102, will turn on at t6 at zero voltage switching conditions. In FIG. 10 is presented an implementation of the current injection source, using the Rompower current injection circuit, depicted in 500.

### Embodiment 4

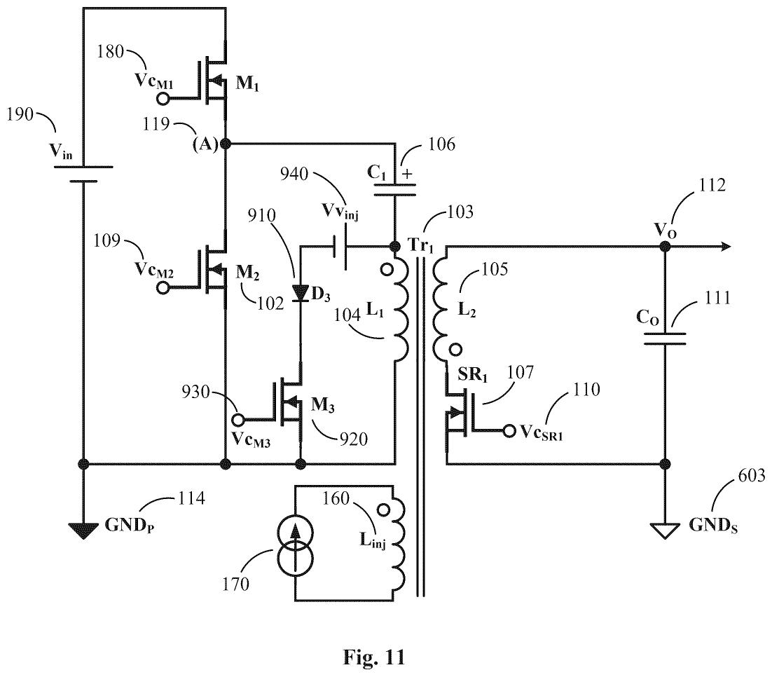

FIG. 11 presents another embodiment in which the polarity of Vvinj, 940 is reversed. In this case the magnetizing energy is injected into the Vvinj, 940, with the purpose of being used for other purposes. One such purpose would be for the current injection. This embodiment is suitable for application wherein the extended dead time it is very large, the time period between t4 to t5, is depicted in FIG. 9. In such case the Vvinj becomes a energy storage device which has the role of storing the energy which would be used to discharge the parasitic capacitance reflected across M1, 101.

In this embodiment, a portion of the magnetizing current energy is stored in Vvinj which becomes Vinj, 270 from the current injection circuit, 500, from FIG. 10. The current injection is the single mechanism for zero voltage switching on M1, 101 and the magnetizing current is stored in Vvinj, 940 to be further used by the current injection.

### Embodiment 5

In Embodiment 5, zero voltage switching across the switching elements is accomplished by the use of current injection technique, as depicted in FIG. 10.

In a half bridge topology, the voltage across each primary switching element swings in between zero level to Vin level. The said “current injection” is activated to charge said M1, 101 from a given voltage level, the worst would be zero, to Vin voltage. The “self-adjusting current injection” is a current injection method wherein the amplitude of said “current injection is self-adjusting from a maximum amplitude to zero function of the voltage across the M1, 101. For example, if said “current injection” is activated when the voltage across M1, 101 is zero the amplitude of the “current injection” shall be negligible, while if the voltage across M1, 101, is at the highest level, such as Vin, the amplitude of said “current injection” shall have the maximum value” determined by design.

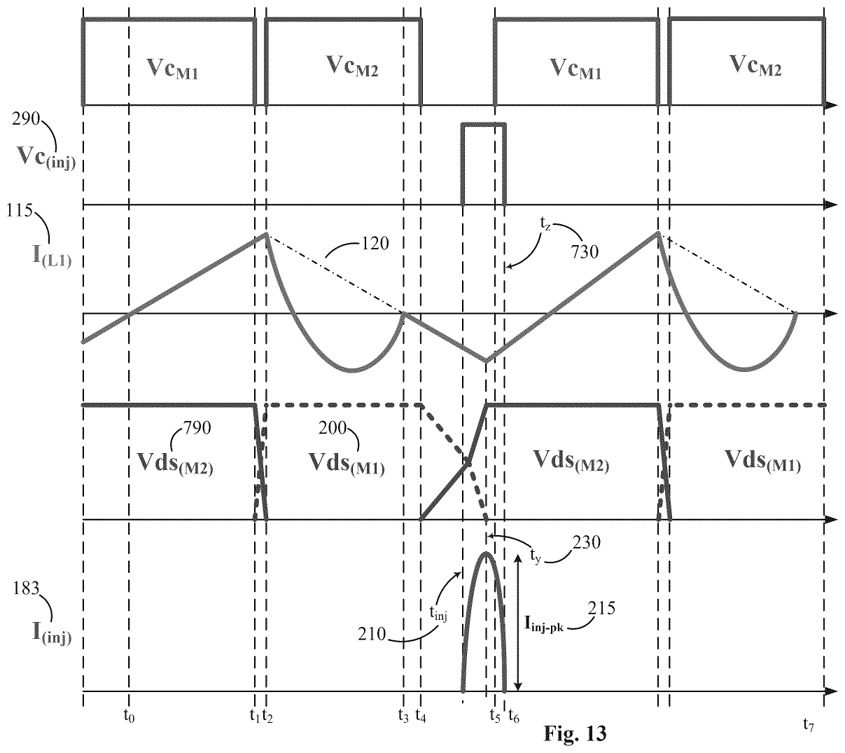

FIG. 13 depicts waveforms for the flyback derived, single ended asymmetrical half bridge with current injection.

At t3 the resonant current in secondary reaches zero and the SR1, 107 turns off. The current in the primary, I(L1), 115, is reduced to the magnetizing current. At t4, the M2, 102, is turned off the magnetizing current will start charging the parasitic capacitance reflected in the switching node A, 119 and in the process the voltage in A, 119, starts increasing from zero towards Vin and the voltage across M2, 102, start decreasing from Vin towards zero. Conventionally, an intelligent controller would assure that the conduction time of M2, 102, was sufficient to increase the negative amplitude of the magnetizing current, 120, to a sufficient level such as the voltage across M1, shall be zero when M1, 101, turns on. That requires precise sensing of the current and sufficient time for calculations which creates delays in the control and limits the increase in frequency. In this embodiment, at tinj, the “current injection” is activated, and a pulse of current is injected in one of the winding of the transformer, such as the auxiliary winding or the secondary winding, or even primary winding. Said “current injection” reflected into the primary winding L1, 104, start charging the parasitic reflected across the switching node “A” at and the voltage across M1, start decaying towards zero ensuring zero voltage switching across M1. In conclusion, in between t4 to tinj, the charging of the parasitic capacitance cross M2 is done by the magnetizing current, 120. The negative amplitude of the magnetizing current may or may not be adequate to totally discharge the parasitic capacitance across M1 prior to the turn on of the M1, to obtain zero voltage switching. The current injection, Iinj, 183 ensures the discharge of the parasitic capacitance across M1 to zero for obtaining zero voltage switching conditions, regardless of the negative amplitude of the magnetizing current. In such cases, the complicated methods of current sensing and the complex calculations are not necessary anymore.

In addition to that the self-adjusting current injection tailors the current injection function of the voltage across M1. At the turn on of the current injection, tinj, the voltage across M1 will determine the amplitude of the current injection Iinj-pk, 215 as depicted in FIG. 13. The self-adjusting current injection feature in this way optimizes the energy consumption for discharging the parasitic capacitance reflected across M1. At t4 when M2, 102, turns off, the magnetizing current 120 starts discharging the parasitic capacitance reflected across M1, 101, as it is depicted by Vds (M1), 200, and this decay continues until tinj, 210. During this time interval the voltage in the switching node A, 119, is increasing from zero to a certain level until tinj, 210. At tinj, 210, the current injection is activated and the parasitic capacitance across M1, 101, will discharge with a higher slope and reach zero at ty, 230 as depicted in FIG. 13. The voltage in A, 119, will reach Vin level also at ty, 230. The amplitude of current injection Iinj-pk, 210 is a function of the voltage amplitude across the M1, 101 at the time tinj, 210, when the current injection is activated. For a larger voltage across M1, the amplitude of the current injection Inj_pk, 210 is larger. The magnetizing current, 120, reduces the amplitude of the voltage across M1, 101, and as a result reduces the Iinj_pk. The magnetizing current and the current injection work together in order to optimize the discharge of the parasitic capacitance across M1 and obtain zero voltage switching. The upper switch, M1, 101, is turned on at t5, after ty, 230 when the voltage across M1, 101, is zero.

The current injection ensures zero voltage switching at each cycle regardless of the magnetizing current amplitude. In an optimized design the magnetizing current will do most of the discharge of the parasitic capacitance across M1, 101 and the current injection will assist to ensure the zero-voltage switching for M1, 101. The self-adjusting characteristic of the current injection will optimize the operation due to the fact that the energy required for the current injection will decrease as the magnetizing current will discharge more of the parasitic capacitance across M11 101.

### Embodiment 6

Another embodiment presented here is the zero-voltage switching in discontinuous mode. In FIG. 5, the power switch M2, 102, has to be turn on for a time interval between t5 to t6 in order to build up the negative amplitude of the magnetizing current. The turn on of the lower switch M2, 102, will lead to some switching losses even if the turn on is done on the valley. In addition to that the increase of the negative polarity of the magnetizing current increases the peak to peak magnetizing current which leads to an increase in magnetic core loss of the transformer Tr1, 103.

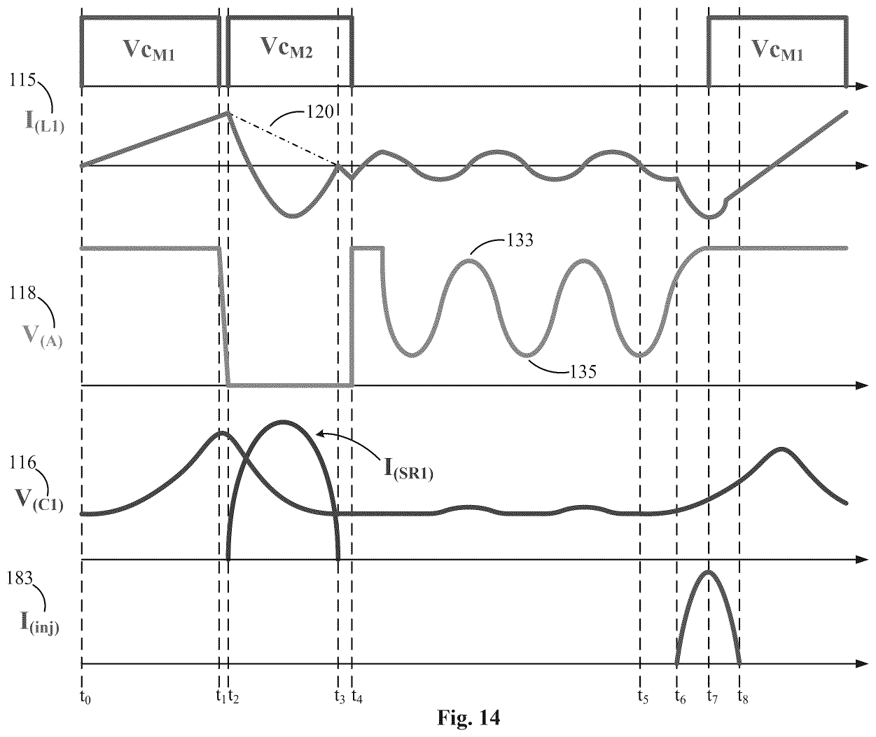

FIG. 14 presents the operation in discontinuous mode wherein an extended dead time is present between t4 to t7 wherein the voltage across M1, 101 experiences a ringing with peaks (hills), 133 and valleys, 135. The current injection Iinj, 183, is activated at t6, and by design is done close to the peak of the ringing to minimize the energy consumption for the current injection. The self-adjusting feature of the current injection reduces the amplitude of the current injection when the activation of the current injection is done at t6 when the voltage in the switching node A, 119 is closer to the Vin level, which means that the voltage across M1, 101, I closer to zero. The self-adjusting feature of the current injection optimizes the energy consumption for zero voltage switching for M1, when the activation of the current injection is done on the peak or the hill, of the ringing during the extended dead time period.

### Embodiment 7

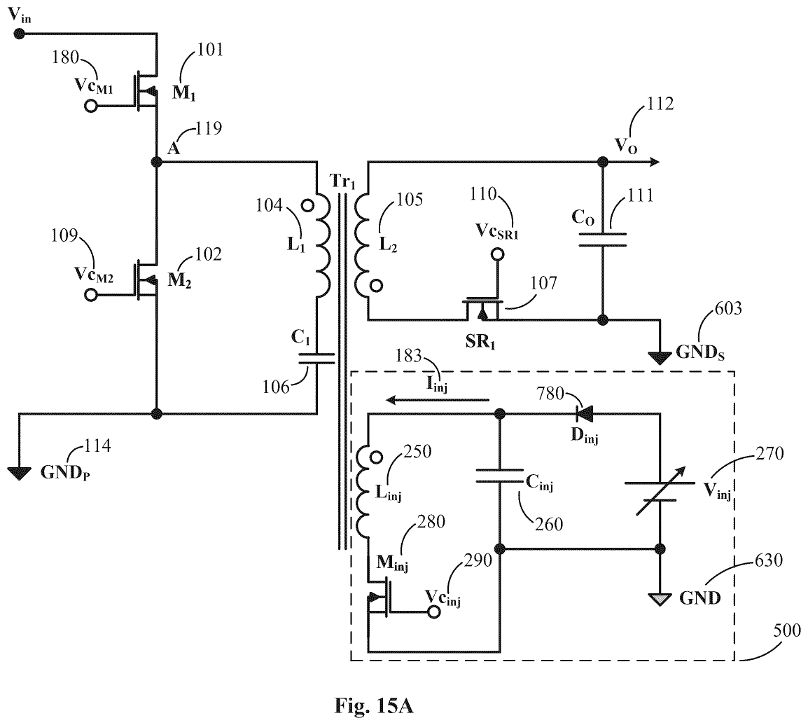

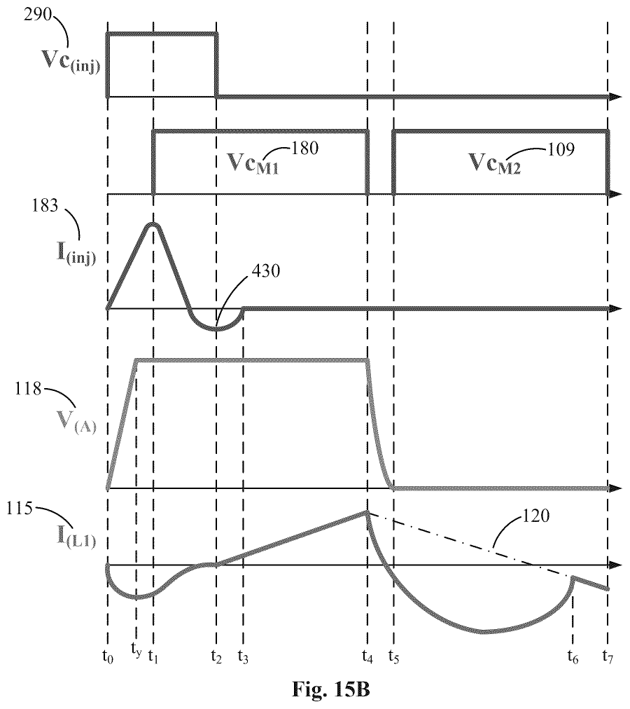

FIG. 15A depicts a schematic of the flyback derived, single ended asymmetrical half bridge. In addition to the standard schematic of the single ended asymmetrical half bridge, as depicted in FIG. 1, in FIG. 15A there is an additional circuit, 500, which represents a current injection circuit.

It includes an auxiliary winding Linj, 250, a current injection switch Minj, 280, controlled by a control signal Vcinj, 290, an optional Cinj, 260, which has the role to shape the current injection and ensure a negative component of the current injection, 430, as depicted in FIG. 15B. The turn off of the current injection switch, Minj, 280, is done during the negative current through Minj, 280, or when the current through Minj, 280 is zero in order to prevent spikes and ringing across it.

The current injection circuit, 500, also includes a current injection diode Dinj, 780 and a voltage injection voltage source Vinj, 270. The GND connection, 630, can be the primary GND, 114 or the secondary GNDs, 603. In many applications, the Vinj can be a bias power or a storage capacitor which harvests energy from the parasitic elements. An example would be harvesting the spikes and ringing across the output rectifier means, SR1, 107, if such spikes do occur or to harvest some of the energy of the voltage across SR1, 107, by soften the dv/dt across SR1, 107 at turn off to further reduce the turn off losses.

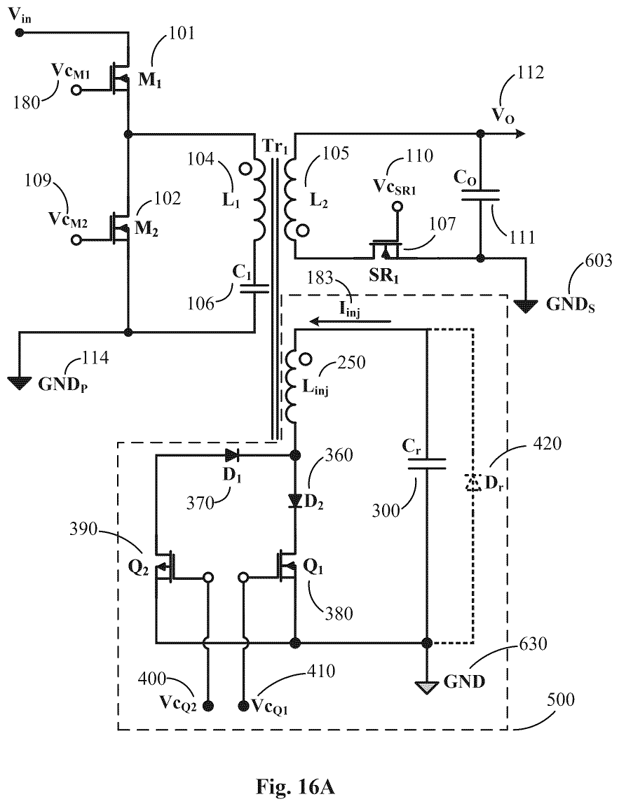

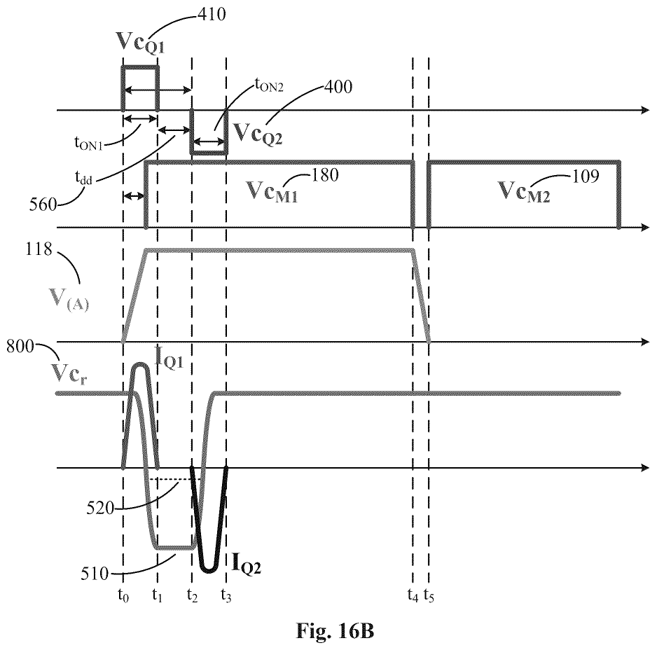

FIG. 16B depicts waveforms associated with the current injection described in U.S. Pat. Nos. 10,574,148 and 11,165,360, referred to in the industry as Rompower Current Injection.

FIG. 15B presents Vc(inj), 290, the control signal for the current injection, also the control signal for the totem pole switching elements, VcM1, 180, VcM2, 109, the current injection 180, the voltage in the switching node A, V(A), 180 and the current through primary winding, I(L1), 115.

At to, the current injection switch is turned on by Vc(inj), 290 prior the turn on of upper switch M1, 180 which turns on at t1. After the current injection switch, Minj, 280, turns on the current injection starts building up reaching a peak as described in U.S. Pat. Nos. 10,574,148 and 11,165,360. The current injection developed by circuit 500, flowing through current injection winding, 250 will reflect into the primary winding, L1, 104, through the coupling between L1 and Linj in the transformer Tr1, 103. The current flows into L1, and into the switching node A, charging the parasitic capacitance reflected across M2, 102 and discharging the reflected parasitic capacitance across M1, 101, towards zero. The voltage in switching node, A, 119, reaches Vin level and the voltage across M1, 101, reaches zero at ty, prior t1, when the M1, 101, is turned on. Further, the magnetizing current flows through M1, 101, the primary winding L1, and into the capacitor C1, 106 extracting energy from Vin and storing it in the magnetizing current of the transformer Tr1, 103, and in the capacitor C1, 106.

At t4 the upper switch M1, 101, turns off and a resonant current is created by the resonant circuit formed by C1, 106 and the leakage inductance in the transformer, Tr1, 103, said resonant current which flows into the secondary and reflects into the primary in between t4 to t6 as depicted in FIG. 15B, by I(L1). The magnetizing current 120, continues to flow until t7, when M2, 102 is turned off.

### Embodiment 8

FIG. 16A depicts a schematic of a flyback derived, single ended asymmetrical half bridge flyback derived using another type of current injection. The Rompower current injection from FIG. 16A, a Vinj, 270 is derived through different means, mostly harvesting the energy from the parasitic elements as previously presented. But FIG. 16A presents another solution for the current injection. It includes a current injection winding Linj, 250, two diodes, D1, 370, D2, 360 and two switching elements, Q1, 380, and Q2, 390. If Mosfets are used for said switching elements, Q1, 380 is a N channel and Q2, 390 it is a p channel.

The mode of operation is depicted in FIG. 16B. FIG. 16B presents the control signals for Q1 and Q2, VcQ1, 410 and VcQ2, 400, the control signals VcM1, VcM2, the voltage in the switching node A, V(A), 118, the current through Q1, IQ1, the current through Q2, IQ2, and the voltage on Vcr, 520, with diode Dr connected, 420, Vcr, 510 with diode Dr, 420 not connected.

In this embodiment, the energy for the current injection which is stored in Cr comes from Vin during the conduction of Q2, 390, wherein a quasi-resonant current is formed by the resonant circuit formed by the leakage inductance in between the Linj, 250 and L1, 104 and the capacitor Cr, 300, wherein a quantum of energy is transferred from Vin to Cr.

For the next cycle prior the turn on of M1, 101, Q1 is turned on by VcQ1, 410. A resonant circuit is formed by the capacitor Cr, 300 and the leakage inductance between Linj, 250 and L1, 104 and a current injection in the shape of a quasi-resonant current Iq1 is produced which will discharge the parasitic capacitance reflected across M1, 101, to zero, prior M1, 101 will turn on. The resonant capacitor Cr, 300 is discharged to zero, as 520, in the case Dr, 420 is connected across Cr, or will change its polarity, as 510, further waiting for the Q2 to be activated and charge Cr, 300, back with energy from Vin.

In this embodiment the resonant capacitor Cr, 300, is charged in a quasi-resonant mode, from Vin when Q2 is turned on and when Q1 is turned on a current injection is produced with the purpose of discharging the parasitic capacitance of M1, 101, to zero.

This method does allow the charge of Cr to be done after M1 is in full conduction wherein M1, 101, has a low impedance. The delay time, Tdd, 560, which is the delay time in between VcQ1, 410 and VcQ2, 400 from FIG. 16B is controlled for an optimized operation. One of the optimization criteria is to activate Q2, only after M1, 101, is fully turned on, and the voltage across it is zero and the voltage in the switching node A, 119 is Vin.

### Embodiment 9

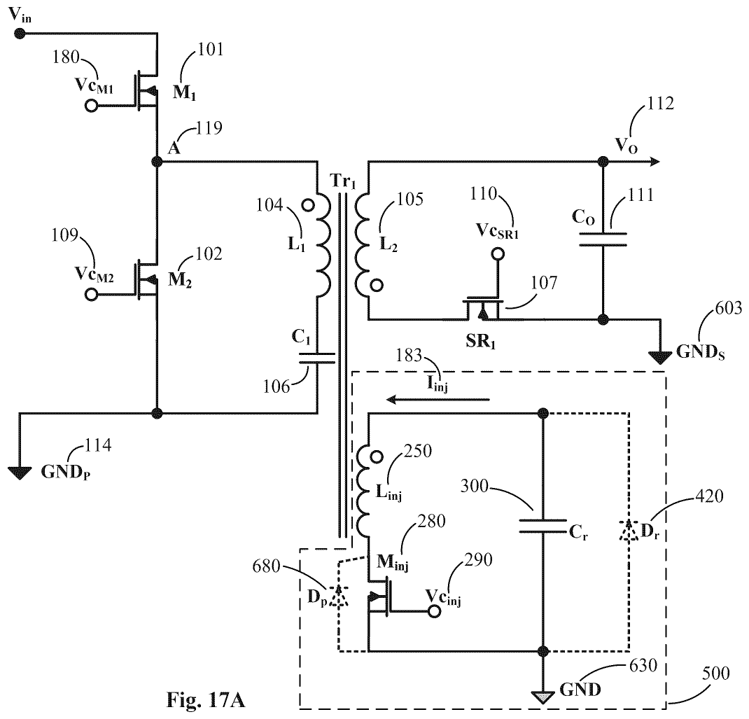

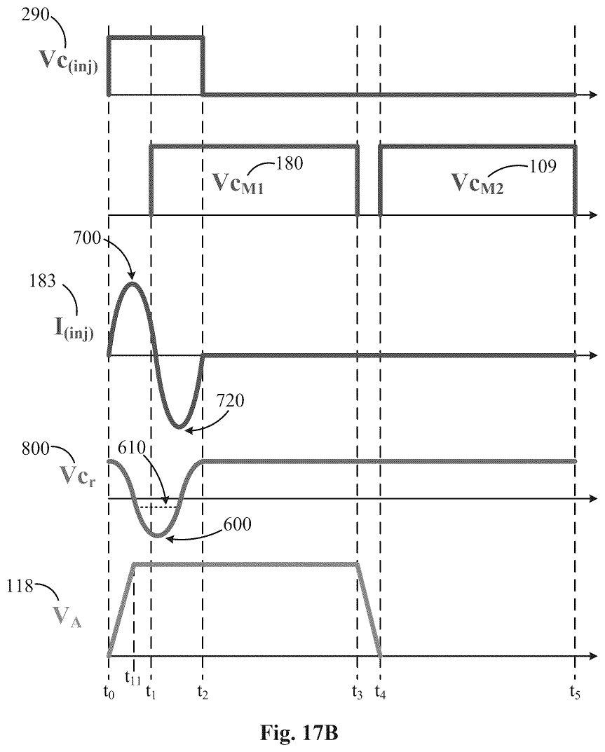

FIG. 17A depicts a schematic of the flyback derived, single ended asymmetrical half bridge using another type of current injection, named “full resonant current injection circuit.” In FIG. 17A the current injection section, 500 has a different configuration in comparison with FIG. 16A and FIG. 15A. FIG. 17A depicts a current injection using a totally resonant current injection circuit.

The circuit is formed by a current injection winding connected to a current injection switch, 280, which is controlled by a signal, 290. As an option in some applications, a diode, Dp, 680, may be placed in parallel with the body diode of Minj, 280. In addition to it there is a current injection capacitor Cr, 300 connected between the source of the current injection switch Minj, 280 and to the termination of the current injection winding, 250, not connected to the current injection switch, 280. In parallel with Cr, 300 there is an optional diode Dr, 420. The effect of Dr, 420 is presented in FIG. 17B wherein the waveforms of the “full resonant current injection” circuit are presented.

Waveforms of the current injection circuit from FIG. 17A are depicted in FIG. 17B such as, Vcinj, 290, VcM1, 180, VcM2, 109, the “full resonant” current injection Iinj, 183, the voltage across Cr, 300, and the voltage in the switching node, A, 119.

At to the current injection switch is turned on. A resonant circuit is formed between the leakage inductance between Linj, 250 and the primary winding L1, 104 and the capacitor Cr, 300, the resonance creates a positive current cycle, 700 and a negative current cycle, 720. The voltage across the capacitor will decay in the resonant way reaching a negative amplitude, 600 and in the case wherein the diode Dr is present will limit the negative swing to the voltage across the diode, 610. The positive current cycle, 700, will discharge the capacitance reflected across M1, 101 and it will discharge it to zero, when the voltage in the switching node A, will reach Vin level at t11. A preferred method of obtaining zero voltage switching is to turn on the switch M1, 101, at t1, immediately after t11, when the voltage across M1 is zero. The negative current cycle, 720 charges again the parasitic capacitance reflected across M1 if M1 is not turned on. The hardware circuit form embodiment 9 is very simple, but under this method, it is preferable that t1>t11 and for optimization t1 is in close proximity of t11 may require some complexity in the control part but with a significant hardware simplification.

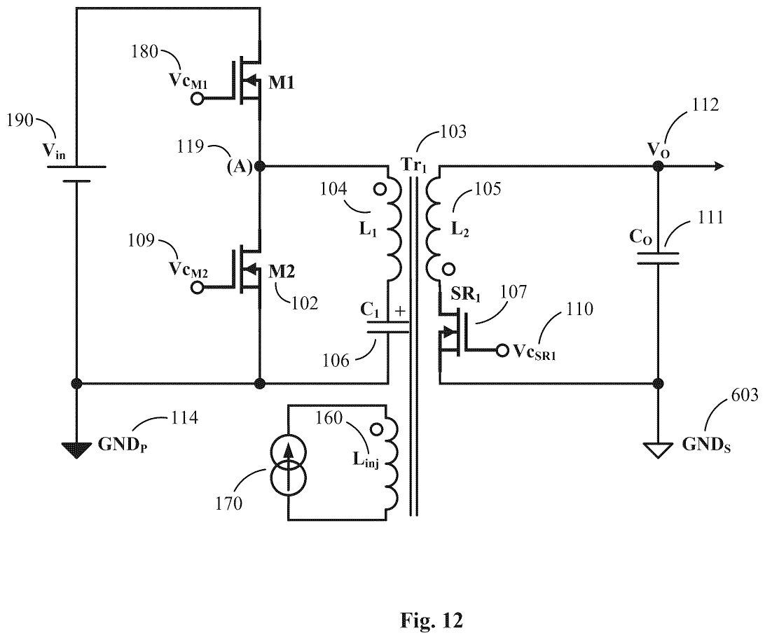

FIGS. 1, 12, 15A, 16A and 17A present different configurations of the flyback derived, single ended asymmetrical half bridge, incorporating a transformer Tr1, having primary winding, secondary winding, and auxiliary winding. In these drawings, the transformer windings do have a dot at one of the terminations which depicts the polarity of the winding. By definition in a transformer having windings with defined polarities identified by the placement of the dot, when an independent current source injects current into one winding at the said winding termination with a dot, a current will be induced in the rest of the windings wherein induced current in said windings will be exiting out of the windings from the dot termination towards the circuit connected to said windings.

### Embodiment 10

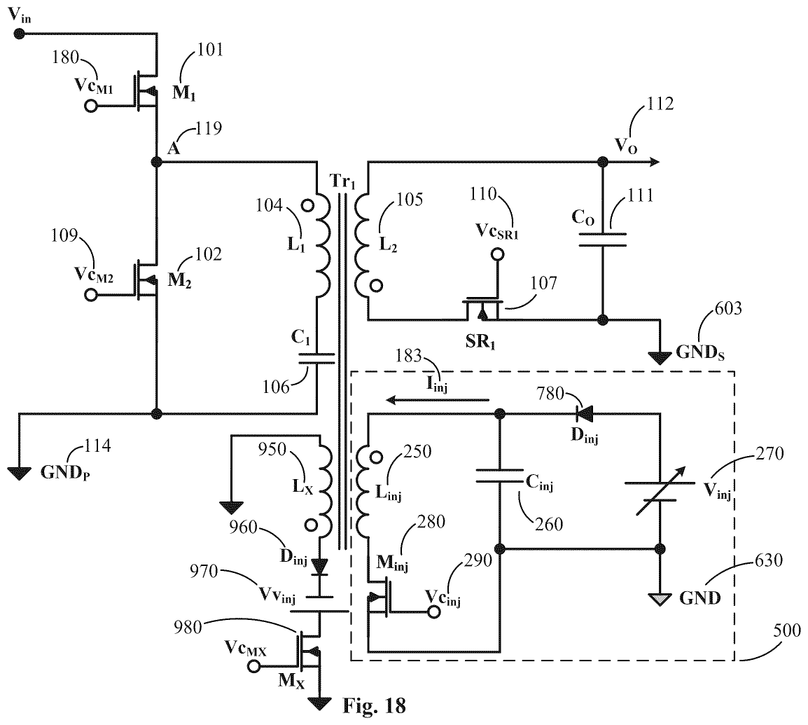

FIG. 18 depicts a schematic of the flyback derived, single ended asymmetrical half bridge using voltage injection formed by Vvinj, D3 and M3 and also current injection from the circuit from the block 500.

In some applications the voltage injection can be incorporated floating in an auxiliary winding Lx, 950, using the voltage injection components, such as Dinj, 960, Vvinj, 970 and a switching element Mx, 980.

The mode of operation of the voltage injection in FIG. 18 is the same as the circuit depicted in FIG. 10.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A method of operating a DC-DC converter comprising:
providing a DC-DC converter having:
a primary side and a secondary side;
an input voltage source;
a transformer having at least one primary winding at the primary side and at least one secondary windings at the secondary side, wherein a leakage inductance is formed between the at least one primary winding and the secondary winding, wherein there is a magnetizing current flowing through the primary and secondary winding;
two switching elements in a totem pole, comprising a lower switching element connected to a first termination of the input voltage source and an upper switching element connected to a second termination of the input voltage source;
a switching node which is a common connection between the lower switching element and the upper switching element;
a resonant capacitor connected to one end of the primary winding, and the resonant capacitor in series with the primary winding connected across the lower switching element;
an output capacitor;
a rectifier means having two power terminations connected with the first power termination to one end of the secondary winding and the end of the secondary winding not connected to the rectifier means, connected to the first termination of the output capacitor, wherein the second termination of the output capacitor is connected to the second power termination of the rectifier means; and
an output load connected across the output capacitor;
the method comprising:
(a) switching on the upper switching element for a time interval referred to as the upper switch on time during which the magnetizing current is building up through the transformer;
(b) the upper switching element is turned off for a time interval referred to as a first dead time period;
(c) the lower switching element is switched on for a for a time interval referred to as the lower switch on time during which the magnetizing current is decaying in amplitude and when the resonant capacitor form a resonant circuit with the leakage inductance of the transformer and a sinusoidal shaped current will flow into secondary winding and rectifier means charging the output capacitor and the sinusoidal shaped current flowing in the secondary reaching zero amplitude at a time named trez;
(d) the lower switch on time is longer than the trez;
(e) the magnetizing current becomes negative reaching a negative amplitude IM-neg;
(f) the lower switching element is turn off for a time interval referred as the second dead time period;
(g) after the second dead time period, the upper switch turns on, initiating another cycle; and
(h) cyclically repeating at least steps (a) through (f).

2. The method according to claim 1, wherein the magnetizing current at the end of the second dead time period has an amplitude sufficient to charge a parasitic capacitance reflected in the switching node to create zero voltage switching conditions for the upper switch at turn on.

3. A method of operating a DC-DC converter comprising:
providing a DC-DC converter having:
a primary side and a secondary side;
an input voltage source;
a transformer having at least one primary winding at the primary side and at least one secondary windings at the secondary side, wherein a leakage inductance is formed between the at least one primary winding and the secondary winding, wherein there is a magnetizing current flowing through the primary and secondary winding;
two switching elements in a totem pole, having a lower switching element connected to a first termination of the input voltage source and an upper switching element connected to a second termination of the input voltage source;
a switching node which is a common connection between the lower switching element and the upper switching element;
a resonant capacitor connected to one end of the primary winding, and the resonant capacitor in series with the primary winding connected across the lower switching element;
an output capacitor;
a rectifier means having two power terminations connected with the first power termination to one end of the secondary winding and the end of the secondary winding not connected to the rectifier means, connected to the first termination of the output capacitor, wherein the second termination of the output capacitor is connected to the second power termination of the rectifier means;
an output load connected across the output capacitor; and
an auxiliary circuit formed by a third switching element in series with a diode and further in series with a floating voltage source Vinj, with its positive polarity connected to an anode of the diode wherein the auxiliary circuit is connected across the primary of the transformer;
the method comprising:
(a) switching on the upper switching element for a time interval referred as the upper switch on time; the upper switch on time wherein the magnetizing current is building up through the transformer;
(b) the upper switching element is turned off for a time interval referred as first dead time period;
(c) the lower switching element is switched on for a for a time interval referred as the lower switch on time wherein the magnetizing current is decaying in amplitude and when the resonant capacitor form a resonant circuit with the leakage inductance of the transformer and a sinusoidal shaped current will flow into secondary winding and rectifier means charging the output capacitor and the sinusoidal shaped current flowing in the secondary reaching zero amplitude at a time named trez;
(d) wherein the third switching element is turned on during the lower switch on time;
(e) the lower switch on time is longer than the trez;
(f) the magnetizing current becomes negative reaching a negative amplitude IM-neg;
(g) the third switching element turns off prior the time the upper switching element turns on with a defined time period;
(h) the lower switching element is turn off for a time interval referred as the second dead time period;
(i) after the second dead time period, the upper switch turns on, initiating another cycle; and
(j) cyclically repeating at least steps (a) through (h).

4. The method according to claim 3, wherein the magnetizing current at the end of the second dead time period has an amplitude sufficient to charge a parasitic capacitance reflected in the switching node to create zero voltage switching conditions for the upper switch at turn on.

5. The method according to claim 3, wherein Vinj has a value such that the negative magnetizing current IM-neg has an amplitude sufficient to charge a parasitic capacitance reflected in the switching node to create zero voltage switching conditions for the upper switch at turn on.

6. The method according to claim 3, wherein Vinj has a value such that increases to a given amplitude for a determined period of time prior to an end of the second dead time so as to charge a parasitic capacitance reflected in the switching node to create zero voltage switching conditions for the upper switch at turn on.

7. A method of operating a DC-DC converter comprising:
providing a DC-DC converter having:
a primary side and a secondary side;
an input voltage source;
a transformer having at least one primary winding at the primary side and at least one secondary windings at the secondary side, wherein a leakage inductance is formed between the at least one primary winding and the secondary winding, wherein there is a magnetizing current flowing through the primary and secondary winding;
two switching elements in a totem pole, having a lower switching element connected to a first end of the input voltage source and an upper switching element connected to a second end of the input voltage source;
a switching node which is a common connection between the lower switching element and the upper switching element;
a resonant capacitor connected to one end of the primary winding, and the resonant capacitor in series with the primary winding both in series connected across the lower switching element;
an output capacitor;
a rectifier means having two power terminations connected with the first power termination to one end of the secondary winding and the end of the secondary winding not connected to the rectifier means, connected to the first termination of the output capacitor, wherein the second termination of the output capacitor is connected to the second power termination of the rectifier means;
an output load connected across the output capacitor;
a current injection winding in the transformer connected to a circuit formed by two legs; wherein the first leg is formed by a p channel mosfet in series with a diode and wherein the second leg is formed by a n channel mosfet in series with a diode;
the current injection winding not connected to the circuit formed by two legs is connected to a current injection capacitor, wherein the termination of the capacitor not connected to the current injection winding is connected to the sources of p channel mosfet and n channel mosfet; and
an auxiliary circuit formed by a third switching element in series with a diode and further in series with a floating voltage source Vinj, with positive polarity, connected to an anode of the diode wherein the auxiliary circuit is connected across the primary of the transformer;
the method comprising:
(a) switching on the upper switching element for a time interval labeled the upper switch on time; the upper switch on time wherein the magnetizing current is building up through the transformer;
(b) the upper switching element is turned off for a time interval labeled first dead time period;
(c) the lower switching element is switched on for a for a time interval labeled the lower switch on time wherein the magnetizing current is decaying in amplitude and when the resonant capacitor form a resonant circuit with the leakage inductance of the transformer and a sinusoidal shaped current will flow into secondary winding and rectifier means charging the output capacitor and the sinusoidal shaped current flowing in the secondary reaching zero amplitude at a time named trez;
(d) wherein the third switching element is turned on during the lower switch on time;
(e) the lower switch on time is longer than the trez;
(f) wherein the magnetizing current becomes negative reaching a negative amplitude IM-neg;
(g) the lower switching element is turn off for a time interval labeled the second dead time period;
(h) the third switching element turns off prior the time the upper switching element turns on with a defined time period;
(i) switching on the n channel mosfet for a given time interval at the end of second dead time, wherein a quasi resonant current pulse is flowing from the current injection capacitor and the current injection winding, further induced in the primary winding and to charge a parasitic capacitance reflected in the switching node to create zero voltage switching conditions for the upper switch at turn on;
(j) after a given time period, during a conduction of the upper switch the p channel mosfet is switched on and a quasi resonant current starts flowing through the primary winding and further induced in the current injection winding, charging the current injection capacitor with energy from the input voltage source;
(k) after the second dead time period, the upper switch turns on, initiating another cycle; and
(l) cyclically repeating at least steps (a) through (j).
